(19) United States
(12) Patent Application Publication
(10) Pub. No.: US 2024/0185292 A1
(43) Pub. Date: Jun. 6, 2024

(54) MULTI-SELLER ADVERTISEMENT ATTRIBUTION

(71) Applicant: META PLATFORMS, INC., Menlo Park, CA (US)

(72) Inventors: German Chiazzo Cardarello, New York, NY (US); Ravi Ramadasu, Newark, CA (US); Ninisa Bajpaie, Danville, CA (US); Jing Wang, San Francisco, CA (US); Pablo Menendez Gonzalez, Menlo Park, CA (US); Mert Canli, Ordu (TR); Zoran Dukic, Los Altos, CA (US); Naresh Panda, Newark, CA (US)

(21) Appl. No.: 18/465,520

(22) Filed: Sep. 12, 2023

Related U.S. Application Data
(60) Provisional application No. 63/442,430, filed on Jan. 31, 2023.

(51) Int. Cl. G06Q 30/0242; G06Q 30/0241; G06Q 30/0601

(52) U.S. Cl. CPC G06Q 30/0246; G06Q 30/0277; G06Q 30/0633

(57) ABSTRACT

Systems, methods, apparatuses, and computer program products provide techniques for multi-seller ad attribution. Various examples and implementations may generate a first advertisement on the online platform, generate a second advertisement on the online platform, track user selections on the online platform, determine purchase information related to products in the virtual cart, generate an attribution report including advertisement performance, and purchase information. The attribution report may provide additional insight, context, and information regarding advertisement campaigns and user interactions.

### CROSS-REFERENCE TO RELATED APPLICATIONS

This application claims the benefit of U.S. Provisional Application No. 63/442,430 filed Jan. 31, 2023, the entire content of which is incorporated herein by reference.

### BACKGROUND

Online advertising may occur on multiple websites and platforms, including social media. In many conventional systems and methods, advertisements may provide a text, photo, or link on a website that may relate to a product, service, and/or a method to purchase the advertised item. In some configurations, a user may select one or more items associated with one or more brands and fill up a virtual cart where the one or more items may be purchased.

In some instances, advertising metrics may be collected based on purchases that occur through a given page or site via the provided link. Brands may run performance analyses based on the success, e.g., purchases, made through ads on certain sites, pages, and other online means. However, traditional methods may often attribute any sales and purchases to the merchant providing the advertised product, which is not necessarily the brand of the product. Purchases containing many products and brands are also not accurately reflected, since purchases are often attributed to a single seller. As such, metrics attributed to the merchant and/or via clicking an advertised link may not provide enough context for a full picture on a user's shopping preferences and purchases. Accordingly, there exists a need for more informative metrics, which may provide additional insight into various offered products and services.

### BRIEF SUMMARY

In meeting the described challenges, the present disclosure provides systems, methods, devices, and computer programming products for multi-seller advertisement attribution. An example may include a computing device comprising at least one processor and at least one memory providing instructions, which when executed by the processor, cause the computing device to at least generate a first advertisement on the online platform, wherein the first advertisement comprises a link to purchase a first product in a product set, generate a second advertisement on the online platform, wherein the second advertisement comprises a link to purchase a second product in the product set, track user selections on the online platform, wherein the user selections comprise adding the first product to a virtual cart via the first advertisement, and adding the second product to the virtual cart via the second advertisement, determine purchase information related to products in the virtual cart, and generate an attribution report comprising advertisement performance and purchase information.

According to an aspect, the first product and the second product may be associated with different sellers. The attribution report may provide, for the first seller, a total purchase value, a number of link clicks, and a number of purchases associated with products provided by the first seller. According to another aspect, the advertisement performance may include a number of user selections of the first advertisement and/or the second advertisement. The attribution report may comprise a total purchase value of products sold via advertisements on the online platform. In various examples, the instructions to track user selections may include tracking selections of the first advertisement, selections of the second advertisement, and virtual cart contents. Additional examples, as discussed herein, may comprise an aggregator providing a product set via at least one advertisement provided on an online platform, wherein at least one of the first advertisement or the second advertisement are provided via the aggregator.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings, exemplary embodiments of the disclosed subject matter; however, the disclosed subject matter is not limited to the specific methods, compositions, and devices disclosed. In addition, the drawings are not necessarily drawn to scale. In the drawings:

FIG. 1 illustrates a multi-party attribution system according to aspects of the present disclosure.

FIG. 2 illustrates various components of a multi-party attribution system components according to aspects of the present disclosure.

FIG. 3 illustrates a flowchart for multi-party attribution according to aspects of the present disclosure.

FIG. 4 illustrates a machine learning and training model according to aspects of the present disclosure.

FIG. 5 illustrates a block diagram of an example device according to aspects of the present disclosure.

FIG. 6 illustrates a computing system according to aspects of the present disclosure.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

Systems, methods, devices, and computer program products discussed herein provide solutions supporting multi-brand ad attributions. Traditional techniques do not provide multi-party attribution for advertisements from third party sellers. Such techniques may be provided for third party sellers running ads on aggregator platforms. As such, aspects discussed herein may enable third party sellers to optimize, target, and measure purchases with attribution distributed among multiple brands.

In various examples, one or more platforms, such as an Ads Signals Processing Pipeline, may identify whether a given purchase contains products from multiple brands. If so, the multi-brand event may be logged to an Attribution System, which may distribute credit fairly among the multiple brands. In some examples, per-brand attribution values may be determined, and data may be logged downstream according to a processing services interface. The processing services interface may provide ranking, optimization, audience, and post-processing operations.

Such techniques may provide accurate reporting for sellers, especially when ads on an online platform may drive the conversion or purchase or another product. Previously, such conversion may not be tracked or recorded, and often, only one-to-one matching of the last click to the purchase is tracked. Thus, in the prior methods, the one click matching may not provide a complete picture into user selections and purchase operations.

Another advantage of various techniques discussed herein, is the ability to enable multiple ads, by multiple sellers on a single online platform, and track the performance of ads in carts and purchases that contain the items from multiple sellers. As such, when a purchase happens, the brands selling products bought in that cart may be identified and attributed their respective amounts for the purchase. Accordingly, the present disclosure allows purchase attribution on a platform to all brands that sell products, and which were purchased in a single cart.

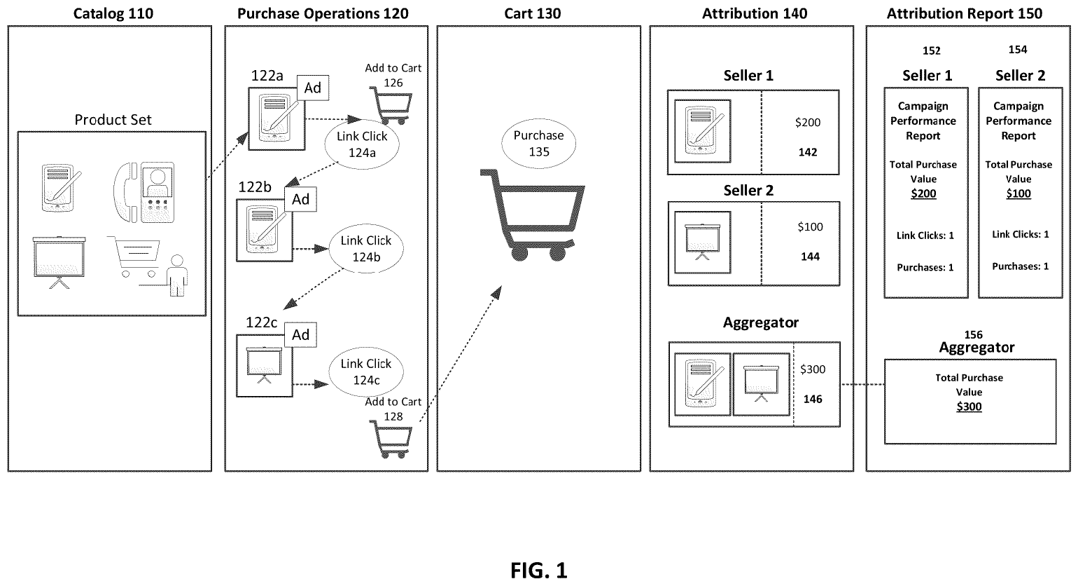

FIG. 1 illustrates a multi-party attribution implementation according to various aspects of the present disclosure. FIG. 1 illustrates various components of the system and operations to enable sellers and buyers to execute a product sale, and how ad attribution contributes towards the processes. A website catalog 110 may include a product set 115. The product set 115 may be representative of all products offered on the website, available for purchase from one or more sellers. The website catalog 110 may receive product information in disparate formats from one or more sellers, compile the information, and provide a product set forming a catalog.

The product set 115 may be presented via a website, such as an online platform. The products may be presented via advertisements. The advertisements may include a text, video, picture, link, or other visual notification on the website to present the product to a user of the website. As discussed herein the website may be an online platform such as a social media platform, online storefront, and the like.

An aggregator may compile the various advertisements and related products for presentation on the online platform. The purchase operations 120 illustrate an example purchase experience for a shopper on the online platform. The website catalog 110 may present an advertisement 122a via the online platform. That advertisement may include a link to the product, and audio, visual, or other information about the product. The advertisement 122a may be selected via a link click 124a, which may provide additional information about the product, and enable the item to be added to a cart 126. In some examples, a link may be provided which relates to a second advertisement 122b, linking to a second product. The second product may be an item related to, commonly bought with, sponsored by, sponsored with, or otherwise associated with the first product. The second advertisement may enable a link 124b, e.g., via an advertisement that leads to a third product 122c. The third product's advertisement 122c may provide a third link 124c, which enable the product to be added to the cart 128.

Purchase operations 120 discussed herein are but one example of user interactions with an online platform, and the ads provided on the platform. Advertisements may provide various links to other products, options to see related products, view products, add products to the cart, and the link.

At section 130, user selections may enable the purchase 135 of items within the cart. Items may be added or removed from the cart, quantities may be changed, and one or more advertisements or suggestions to other products may be included on the purchase page.

Once the purchase 135 occurs, Attribution Operations 140 may determine attribution to various sellers. In the example discussed herein, the first item added to the cart via first advertisement 122a may be provided by a first seller, and the second item added to the cart via third advertisement 122c may be provided by a second seller. Attribution Operations determine a total purchase value of the purchased items, as well as a breakdown of which items may be attributed to the first seller and the second seller.

For example, the first item may have a value of $200, and the second item may have a second value of $100. The attribution to the first seller 142 is therefore $200, and the attribution to the second seller 144 is $100. The total purchase value 146 is $300. The attribution determination to respective sellers may be based on the advertisement, and the seller associated with the item in the advertisement.

An Attribution Report 150 may provide the breakdown to respective sellers and aggregator. A Seller Report may include a total purchase value, a number of link clicks (e.g., link clicks via an advertisement, a total number of purchases and/or purchased items. The Seller Report 152, 154 may be customized with more or less metrics regarding sales, including but not limited to where or how the item was purchased (e.g., via an app), purchase metrics (e.g., conversion value), and the like. An Aggregator Report 156 may include a total purchase value, a number of link clicks, and a total number of purchases made. The Aggregator Report may be a combination of the information in the individual seller reports and relate to a totality of the sales of products purchased from the catalog 110. Similar to the Seller Reports, the Aggregator Report may be customized with more or less sale and purchase metrics.

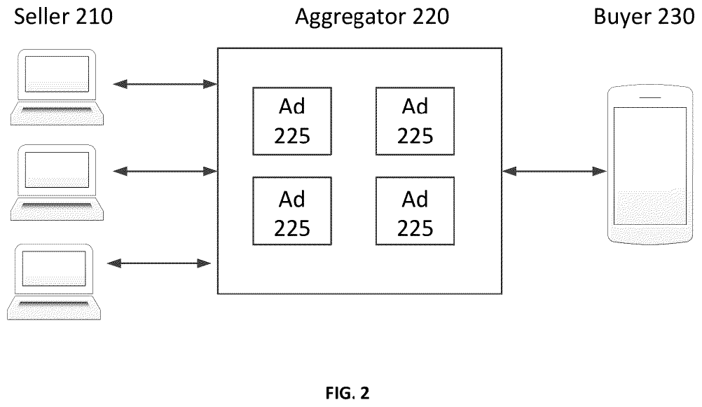

FIG. 2 illustrates an overview of various components in a multi-seller attribution system according to various aspects discussed herein. Systems and methods may generally include one or more sellers 210, an aggregator 220, and a buyer 230. The seller 210 may include one or more seller systems, such as computing systems, databases, and the like, providing a set of products to be compiled at the aggregator 220. Sellers may provide diverse, disparate information, in different formats to the aggregator. The information may be indicative of product offerings, sales, advertisement information, and the like.

The aggregator 220 may act as an intermediary between the sellers and the buyer. The aggregator 220 may provide a product catalog, as discussed herein, and provide one or more advertisements 225 relating to one or more products offered by a seller. The aggregator 220 may provide such advertisements and product information on an online platform, such as a social media platform.

The buyer 230 may access the online platform and/or website via a computing device, for example a mobile computing device, desktop, smartphone, and the like. The buyer 230 may see advertisements and/or products provided by the aggregator, and compiled from the available product offerings of the seller(s) 210. Purchase operations, as discussed with respect to FIG. 1 may occur, items may be added to a virtual cart, and purchases may be completed via the buyer computing device.

The aggregator 220 may generate the Seller Report and Aggregator Report as discussed herein and provide such reports to sellers and/or other computing devices granted access to review the report. In various examples, Sellers may be provided an individual report, with information specific to the products offered by that seller. If, for example, multiple sellers are related to and/or are associated with multiple purchased products, then a combined seller report and in some cases, the aggregator report may be provided to the seller.

Various implementations may include a multiplexer logic, which enables the breakdown of purchases and extraction of item value from the different brands, so that the value may be broken down across different brands and respectively attributed. Such techniques may be applied onto existing advertisement infrastructure, thus making it adaptable and building upon reporting techniques. Such implementations may positively impact targeting, and open business opportunity and availability, for example, in terms of the numbers and types of sellers that may run and drive advertisements campaigns.

The following description provide additional examples and implementations of multi-seller ad attribution systems, methods, devices, and techniques, applicable on the configurations and examples discussed herein.

In a first example, an aggregator may provide a product catalog. A buyer may click on an advertisement from Seller A for Product A. Thus, Product A is associated with Seller A and provided on an online platform via the aggregator.

The buyer may add Product A to a cart, click on another advertisement from Seller A, and click on a third advertisement, for Product B provided by Seller B. Product B may be added to the cart, and the cart may be purchased. So the buyer purchases Product A and B via the aggregator.

In prior implementations, only Seller B would be attributed the value of the purchase, since the last click related to the third advertisement for Seller B's Product B. Seller A would not be attributed any value, even though its initial advertisement regarding Product A drove the conversion of the Product B purchase. Thus, the present disclosure may enable more accurate reporting and an improvement(s) upon the one-to-one matching to the last click, by at least tracking user selections and determining a proper attribution to various sellers.

Such changes are advantageous at least because Sellers may use the attribution information in the development and implementation decisions related to its ads. Such sellers are provided additional information regarding their advertisement campaign and receive attribution, e.g., for conversions, where it would have otherwise been lost.

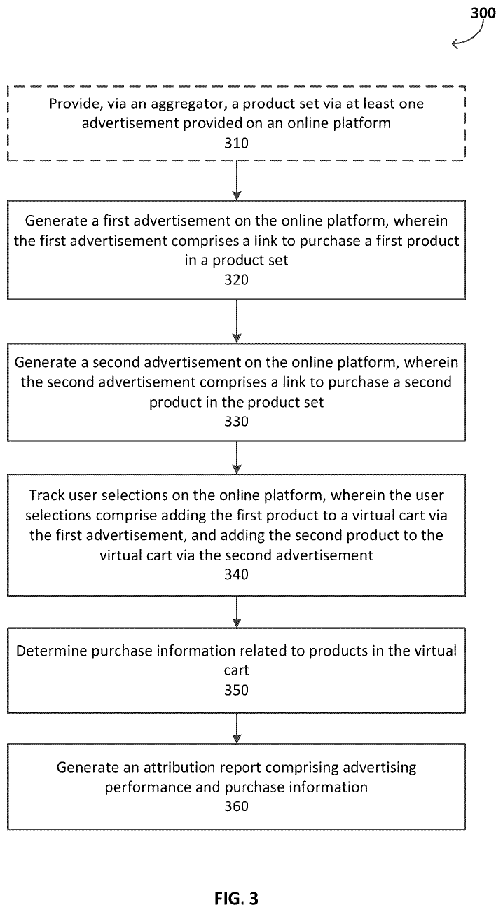

FIG. 3 illustrates a flow chart for multi-party ad attribution in accordance with various aspects discussed herein. Multi-party ad attribution 300 enables various products and services to be attributed to respective sellers, thus providing information, insight, and context regarding advertisements provided on an online platform, such as a social media platform.

At block 310, an aggregator may optionally provide a product set via at least one advertisement provided on an online platform. The aggregator may be a framework which enables multiple parties to provide advertisements on a platform, such as social media platform, a website and the like. The aggregator may enable advertisement customization, linking to a desired site, product or service page, or other aspect, as desired by the seller. An online platform may be in communication with the aggregator to receive and provide the information, including but not limited to product information, on the online platform. According to various aspects, the aggregator may provide a product set via at least one advertisement provided on the online platform.

At block 320, aspects may generate a first advertisement on the online platform. The first advertisement may comprise a link to purchase a first product in a product set. At block 330, aspects may generate a second advertisement on the platform. The second advertisement may comprise a link to purchase a second product in the product set. In various aspects, the first product and the second product may be provided by different sellers. As discussed herein, the product set may comprise products provided by a plurality of sellers, be associated with one or more brands, and include a set of products available for purchase via the online platform and/or a linked destination provided via the online platform.

At block 340, aspects may track user selections on the online platform. The user selections may comprise adding the first product to a virtual cart via the first advertisement and adding the second product to the virtual cart via the second advertisement. User selections may include, but are not limited to, clicks on a link, advertisement, product description, or other selection associated with the product. Aspects may further include tracking selections of the first advertisement, selections of the second advertisement, and virtual cart contents. The user selections may further comprise information related to a time of selection, an order of selection, a set of selections, and other aspects related to the user interaction with one or more advertisements, products, services, posts, texts, pictures, selections, objects, and items on the online platform.

At block 350, aspects may include determining purchase information related to products in the virtual cart. Purchase information may include, but is not limited to a quantity of items purchased, a listing of items purchased, a time of purchase, advertisements leading to the addition of the item to the cart, and other details related to one or more of the product(s) purchased, a method of purchasing the product, user actions/selections related to the product purchase, related items to one or more purchased item, addition, change, and deletion history of the cart, and the like.

At block 360, aspects may generate an attribution report comprising advertising performance and purchase information. The attribution report, discussed herein, may include, for one or more sellers associated with a purchased product, one or more of: a total purchase value, a number of link clicks, and a number of purchases associated with products provided by the first seller.

In some examples, the attribution report may provide, for the first seller, a total purchase value, a number of link clicks, and a number of purchases associated with products provided by the first seller. In other examples, the attribution report may provide, for the second seller, a total purchase value, a number of link clicks, and a number of purchases associated with products provided by the first seller. The attribution report may be provided, for example, on a graphical user interface, as a dashboard on a display device, and the like.

In some examples, the advertisement performance on the attribution report may include a number of user selections of the first advertisement and/or the second advertisement. The attribution report may also include a total purchase value of products sold via advertisements on the online platform.

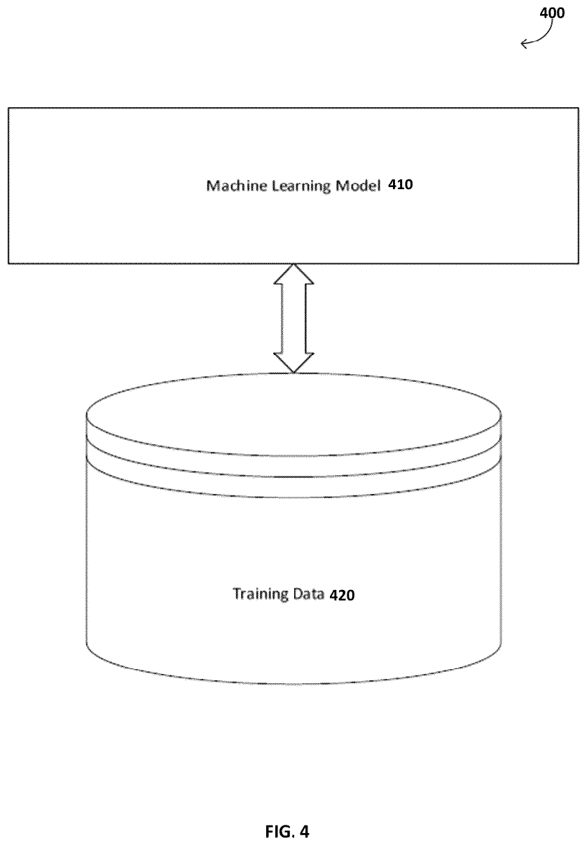

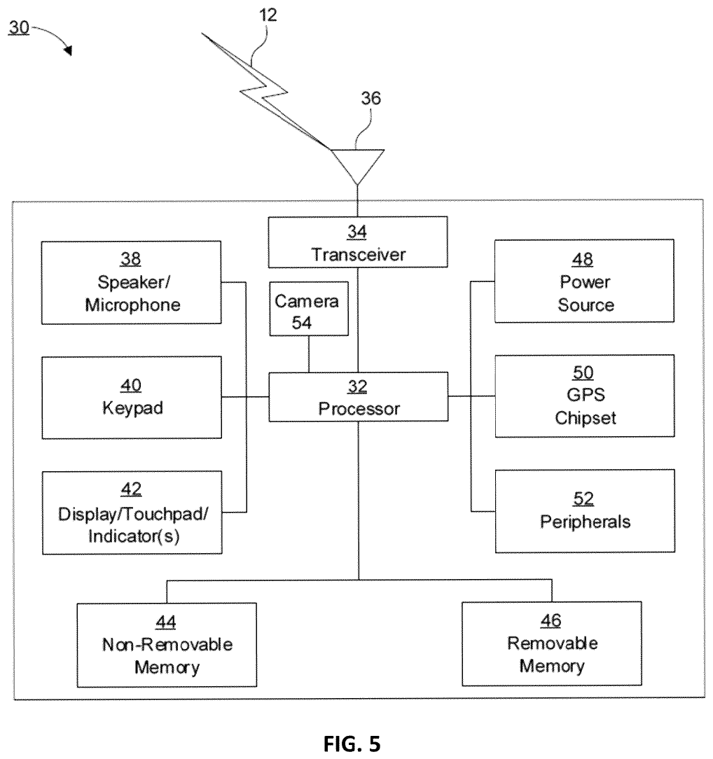

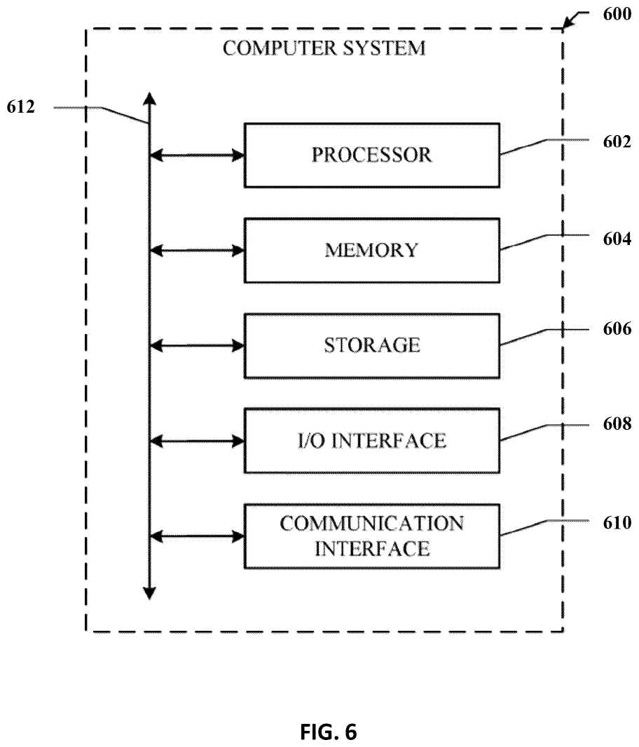

FIG. 4 illustrates a framework 400 employed by a software application (e.g., algorithm) for evaluating attributes of a gesture. The framework 400 can be hosted remotely. Alternatively, the framework 400 can reside within the UE 30 shown in FIG. 5 and/or be processed by the computing system 600 shown in FIG. 6. The machine learning model 410 is operably coupled to the stored training data in a database 420. In some example embodiments, the machine learning model 410 may be associated with operations of block 360 of FIG. 3. In some other examples, the machine learning model 410 may be associated with other operations. The machine learning model 410 may be implemented by one or more machine learning module(s) and/or another device (e.g., AR device 110).

In an exemplary embodiment, the training data 420 can include attributes of thousands of objects. For example, the object can be a smart phone, person, book, newspaper, sign, car, and the like. Attributes can include but are not limited to the size, shape, orientation, position of the object, etc. The training data 420 employed by the machine learning model 410 can be fixed or updated periodically. Alternatively, the training data 420 can be updated in real-time based upon the evaluations performed by the machine learning model 410 in a non-training mode. This is illustrated by the double-sided arrow connecting the machine learning model 410 and stored training data 420.

In operation, the machine learning model 410 can evaluate attributes of images, advertisements, products, etc. obtained by hardware. For example, the UE 30 shown in FIG. 5 may receive a product set, advertisements, purchase data, user selections, and the like. The attributes of the received data (e.g., purchase information, available products, items added to the cart, purchase link clicks, etc.) may then be compared with respective attributes of stored training data 420 (e.g., prestored objects). The likelihood of similarity between each of the obtained attributes (e.g., of the captured image of an object(s)) and the stored training data 420 (e.g., prestored objects) is given a confidence score. In one exemplary embodiment, if the confidence score exceeds a predetermined threshold, the attribute is included in an image description that is ultimately communicated to the user via a user interface of a computing device (e.g., UE 30, computing device). In another exemplary embodiment, the description can include a certain number of attributes which exceed a predetermined threshold to share with the user. The sensitivity of sharing more or less attributes can be customized based upon the needs of the particular user, seller, aggregator, and the like.

FIG. 5 illustrates a block diagram of an exemplary hardware/software architecture of a UE 30. As shown in FIG. 5, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an exemplary embodiment, the camera 54 is a smart camera configured to sense images appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment via network 12. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

FIG. 6 illustrates an example computer system 600. In exemplary embodiments, one or more computer systems 600 perform one or more steps of one or more methods described or illustrated herein. In particular embodiments, one or more computer systems 600 provide functionality described or illustrated herein. In exemplary embodiments, software running on one or more computer systems 600 performs one or more steps of one or more methods described or illustrated herein or provides functionality described or illustrated herein. Exemplary embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example, and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In exemplary embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In exemplary embodiments, processor 602 includes hardware for executing instructions, such as those making up a computer program. As an example, and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In exemplary embodiments, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In exemplary embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In exemplary embodiments, storage 606 includes mass storage for data or instructions. As an example, and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In exemplary embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In exemplary embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In exemplary embodiments, communication interface 610 includes hardware, software, or both providing one or more interfaces for communication (such as, for example, packet-based communication) between computer system 600 and one or more other computer systems 600 or one or more networks. As an example, and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example, and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which may be executed by a computer processor for performing any or all of the steps, operations, or processes described.

Embodiments also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A system, comprising:
a computing device comprising at least one processor and at least one memory providing instructions, which when executed by the processor, cause the computing device to at least:
generate a first advertisement on the online platform, wherein the first advertisement comprises a link to purchase a first product in a product set;
generate a second advertisement on the online platform, wherein the second advertisement comprises a link to purchase a second product in the product set;
track user selections on the online platform, wherein the user selections comprise adding the first product to a virtual cart via the first advertisement, and adding the second product to the virtual cart via the second advertisement;
determine purchase information related to products in the virtual cart; and
generate an attribution report comprising advertisement performance and purchase information.

2. The system of claim 1, wherein the first product and the second product are associated with different sellers.

3. The system of claim 2, wherein the attribution report provides, for the first seller, a total purchase value, a number of link clicks, and a number of purchases associated with products provided by the first seller.

4. The system of claim 1, wherein the advertisement performance comprises a number of user selections of the first advertisement and/or the second advertisement.

5. The system of claim 1, wherein the attribution report comprises a total purchase value of products sold via advertisements on the online platform.

6. The system of claim 1, wherein the instructions to track user selections comprise tracking selections of the first advertisement, selections of the second advertisement, and virtual cart contents.

7. The system of claim 1, further comprising: an aggregator in communication with the computing device, the aggregator providing a product set via at least one advertisement provided on an online platform, wherein at least one of the first advertisement or the second advertisement are provided via the aggregator.

8. A method, comprising:
providing a first advertisement on an online platform, wherein the first advertisement comprises a link to purchase a first product;
providing, via the aggregator, a second advertisement on the online platform, wherein the second advertisement comprises a link to purchase a second product;
tracking user selections on the online platform, wherein the user selections comprise adding the first product to a virtual cart via the first advertisement and adding the second product to the virtual cart via the second advertisement;
determining purchase information related to products in the virtual cart; and
generating an attribution report comprising advertisement performance and purchase information.
